(19) United States
(12) Patent Application Publication
(10) Pub. No.: US 2005/0133581 A1
(43) Pub. Date: Jun. 23, 2005

(54) Automatic actuation device and method for use in punching apparatus

(75) Inventor: Pei-Yuan Lee, Taipei (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 10/987,705

(22) Filed: Nov. 12, 2004

(30) Foreign Application Priority Data
Dec. 23, 2003 (TW) 092136611

(51) Int. Cl. B26D 1/00; B26D 3/00; B26D 5/00

(52) U.S. Cl. 234/2; 83/13; 83/58; 83/72; 83/76.8; 83/370

(57) ABSTRACT

An actuation device includes a first signal generator, a first signal receiver and a signal discriminator. The first signal generator generates a first signal in a first preset pattern. The first signal receiver is used for receiving the first signal. The signal discriminator is electrically connected to the first signal receiver to determine whether the first signal receiver receives the first signal in the first preset pattern, and asserts an actuation signal to actuate a punching operation of the punching apparatus when the first signal is interrupted from the first preset pattern.

### FIELD OF THE INVENTION

The present invention relates to an automatic actuation device and an automatic actuation method, and particularly to an automatic actuation device and an automatic actuation method for use in a punching apparatus.

### BACKGROUND OF THE INVENTION

A punching apparatus is widely used to punch holes in an edge margin of a stack of paper sheets to be filed. With the increasing demand on enhancing punching speed and saving effort, automatic punching apparatuses are developed. Referring to FIG. 1, a conventional automatic punching apparatus is shown. The automatic punching apparatus 10 comprises a base 11, a cutting tool 12, a fixture plate 13, a motor 14 and a button switch 15. The cutting tool 12 has a plurality of punch pins 120 parallel to one another. The fixture plate 13 has a plurality of openings 130 corresponding to the punch pins 120. The region between the cutting tool 12 and the fixture plate 13 defines a feeding entrance 17 for feeding therefrom paper sheets to be punched.

For punching holes, the paper sheets 16 are firstly placed on a top surface of the base 11 with a front thereof fed into the feeding entrance 17. The button switch 15 is then pressed down so as to actuate the motor 14. The cutting tool 12 is driven by the motor 14 to transmit the plurality of punch pins 120 to move downward and dig into the paper sheets, thereby punching holes on the paper sheets.

When operating the above automatic punching apparatus, the user generally holds the paper sheets 16 with one hand and pushes the button switch 15 with the other hand. Therefore, misalignment of paper sheets may occur. In addition, when the number of paper sheets fed into the feeding entrance 17 is small, well alignment of paper sheets cannot be easily accomplished because they are too light to well sustain against the alignment wall inside the feeding entrance 17.

Referring to FIG. 2, another conventional automatic punching apparatus for solving the above problem is shown. In the automatic punching apparatus 20, the base 11, the cutting tool 12, the fixture plate 13 and the motor 14 included therein are similar to those shown in FIG. 1, and are not to be redundantly described herein. This automatic punching apparatus 20 is actuated by stepping on the pedal of a pedal switch 25 after the paper sheets 16 have been properly disposed inside the feeding entrance 17. The additional pedal switch 25 apparently requires additional operating space and results in increased fabricating cost.

### SUMMARY OF THE INVENTION

The present invention provides an actuation device and an actuation method of a punching apparatus so as to enhance alignment of the paper sheets to be punched in limited operating space.

The present invention also provides an automatic punching apparatus having such an actuation device.

In accordance with a first aspect of the present invention, there is provided with an actuation device of a punching apparatus. The actuation device comprises a first signal generator, a first signal receiver and a signal discriminator. The first signal generator generates a first signal in a first preset pattern. The first signal receiver is used for receiving the first signal. The signal discriminator is electrically connected to the first signal receiver to determine whether the first signal receiver receives the first signal in the first preset pattern, and asserts an actuation signal to actuate a punching operation of the punching apparatus when the first signal is interrupted from the first preset pattern.

In an embodiment, the first preset pattern is to have the first signal generator continuously generate the first signal and have the first signal receiver continuously receive the first signal. The actuation signal is asserted when the first signal is interrupted from continuous generation for a predetermined time period.

In another embodiment, the first preset pattern is to have the first signal generator periodically generate the first signal and have the first signal receiver periodically receive the first signal.

Preferably, the first signal is an infrared-ray (IR) signal.

In an embodiment, the punching apparatus comprises a base, a controlled switch, a cutting tool and a fixture plate. The base is used for placing thereon an object to be punched. The controlled switch is electrically connected to the signal discriminator and the motor, and switched on to actuate the motor in response to the actuation signal. The cutting tool has a plurality of punch pins driven by the motor to dig into the object so as to perform the punching operation. The fixture plate has a plurality of openings for receiving the punch pins, wherein a feeding entrance is defined between the cutting tool and the fixture plate defining for feeding therefrom the object to be punched.

In an embodiment, the first signal generator and the first signal receiver are arranged at the same side of the base and opposite to each other so that the object, once placed into the feeding entrance, interrupts the first signal in the first preset pattern.

In an embodiment, the actuation device further comprises a second signal generator and a second signal receiver. The second signal generator is disposed at a side of the base distant from the first signal generator and generates a second signal in a second preset pattern. The second signal receiver is used for receiving the second signal in the second preset pattern. The second signal receiver is electrically connected to the signal discriminator and disposed at the same side of the base as the second signal generator. The signal discriminator asserts the actuation signal when both of the first and the second signal are interrupted from the first and second preset patterns, respectively, by the object placed into the feeding entrance.

Preferably, the second signal is an infrared-ray (IR) signal.

In an embodiment, the signal discriminator is a micro-controller.

Preferably, the actuation device is suitable for use in a paper puncher.

In accordance with a second aspect of the present invention, there is provided with an automatic punching apparatus. The automatic punching apparatus comprises a base, a cutting tool, a photo-sensing module, a controlled switch and a motor. The base is used for placing thereon an object to be punched. The cutting tool digs into the object to create holes. The photo-sensing module is disposed around a feeding entrance where the object is inserted between the base and the cutting tool, and generates an actuation signal when the photo sensing module detects the object has been in place. The controlled switch is electrically connected to the photo-sensing module and switches on in response to the actuation signal. The motor is electrically connected to the controlled switch and actuated to transmit the cutting tool to dig into the object when the controlled switch is on.

In accordance with a third aspect of the present invention, there is provided with a method for automatically actuating a punching apparatus. Firstly, at least one optical way is provided in a paper-feeding entrance of the punching apparatus. Then, it is monitored whether the optical way is interrupted. Then, an actuation signal is generated when the optical way is interrupted for a predetermined time period. Afterward, the punching apparatus is actuated to perform a punching operation in response to the actuation signal.

In an embodiment, two optical ways distant from each other are provided in the paper-feeding entrance, and the actuation signal is generated when both of the optical ways are interrupted for the predetermined time period.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a perspective view showing a conventional automatic punching apparatus operated by pushing down a button switch;

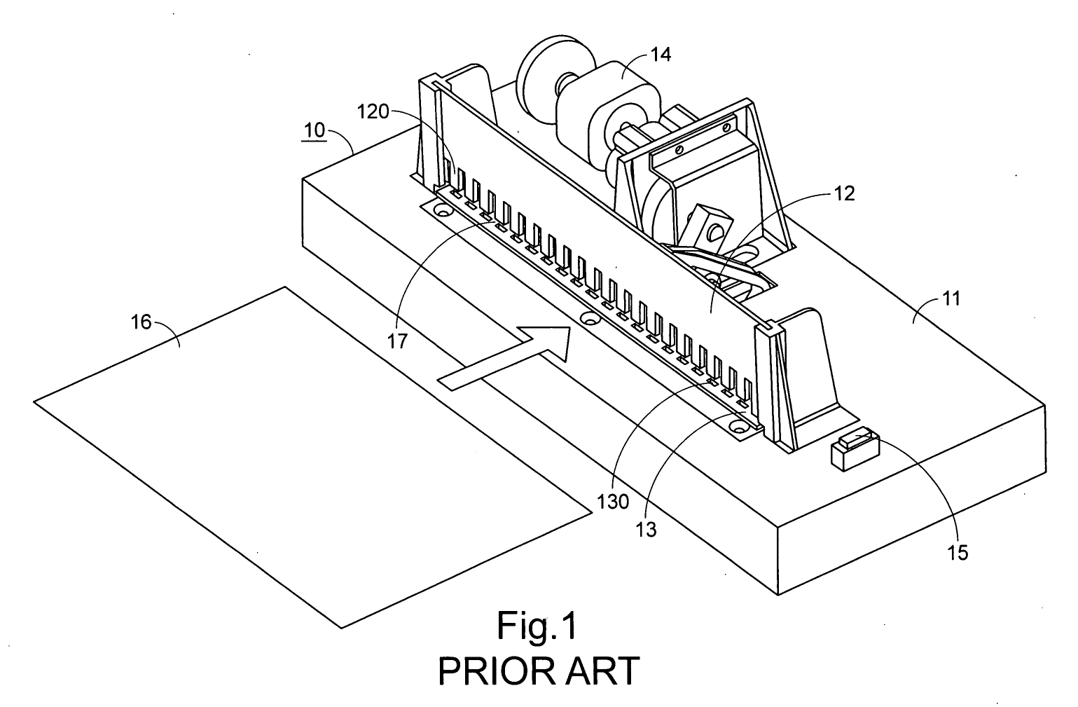

FIG. 2 is a perspective view showing another conventional automatic punching apparatus operated by stepping on the pedal of a pedal switch;

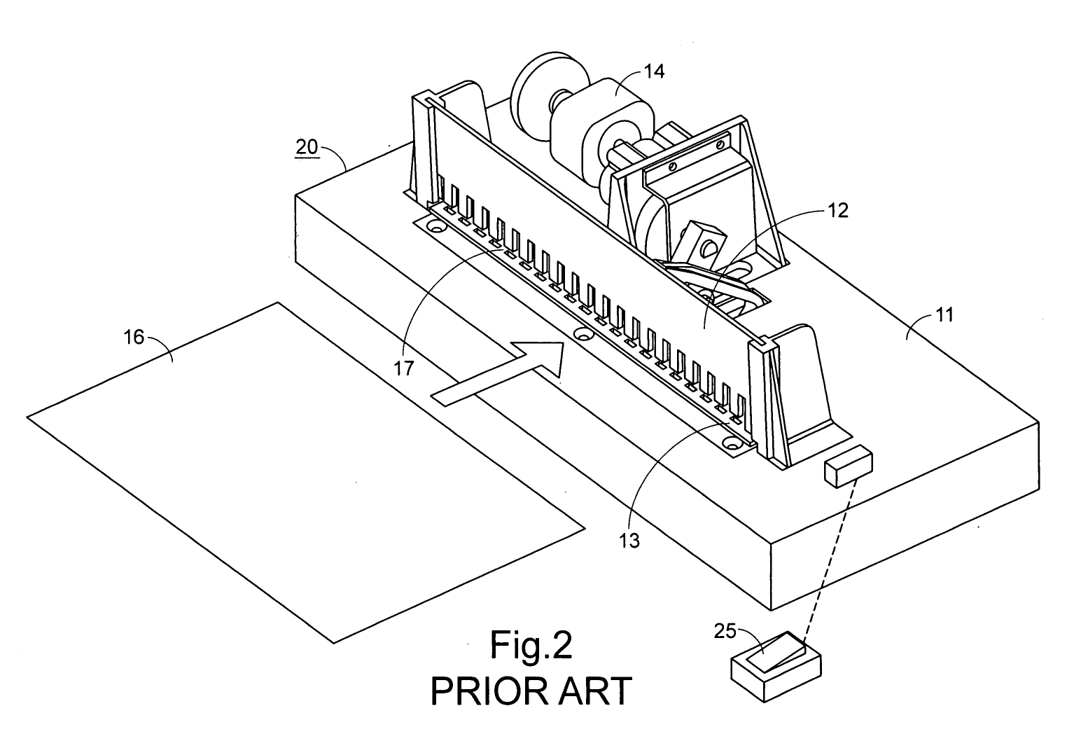

FIG. 3 is a perspective view showing an automatic punching apparatus according to an embodiment of the present invention;

FIG. 4 is a functional diagram schematically illustrating actuation device of the automatic punching apparatus in FIG. 3;

FIG. 5 is a perspective view showing an automatic punching apparatus according to another embodiment of the present invention; and

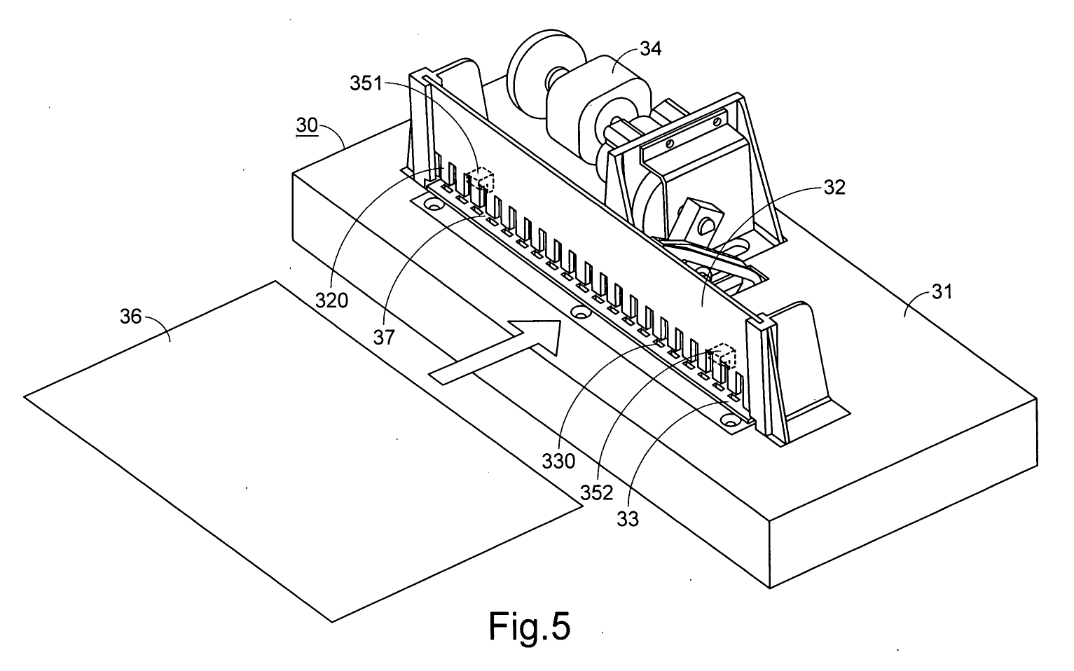

FIG. 6 is a functional diagram schematically illustrating actuation device of the automatic punching apparatus in FIG. 5.

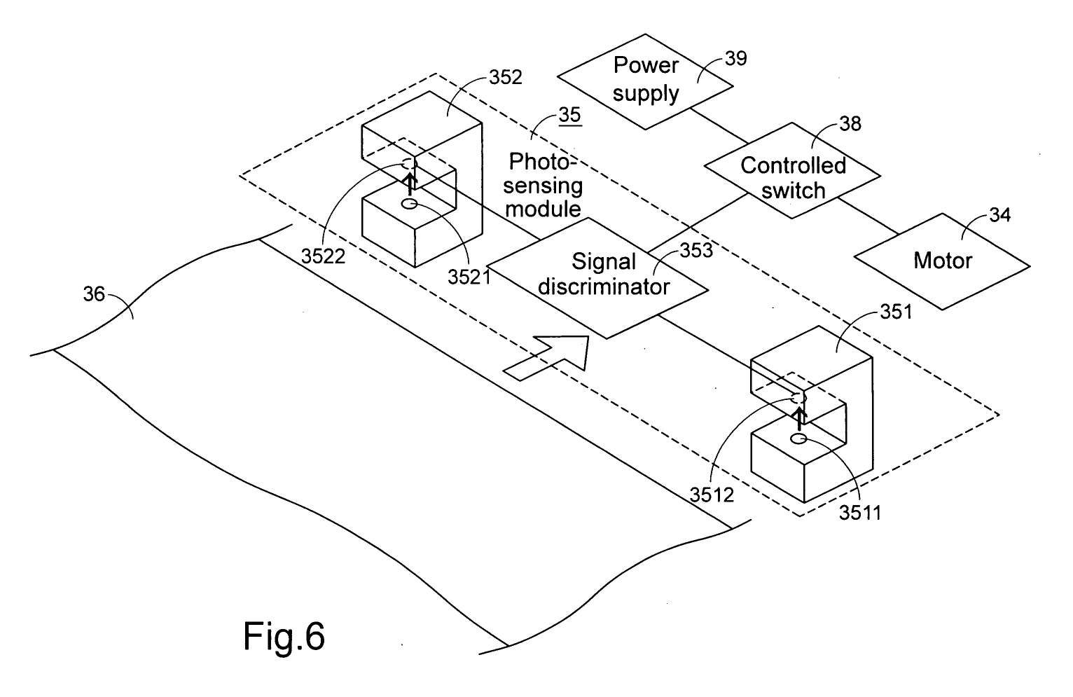

### DETAILED DESCRIPTION OF THE PREFERRED EMBODIMENT

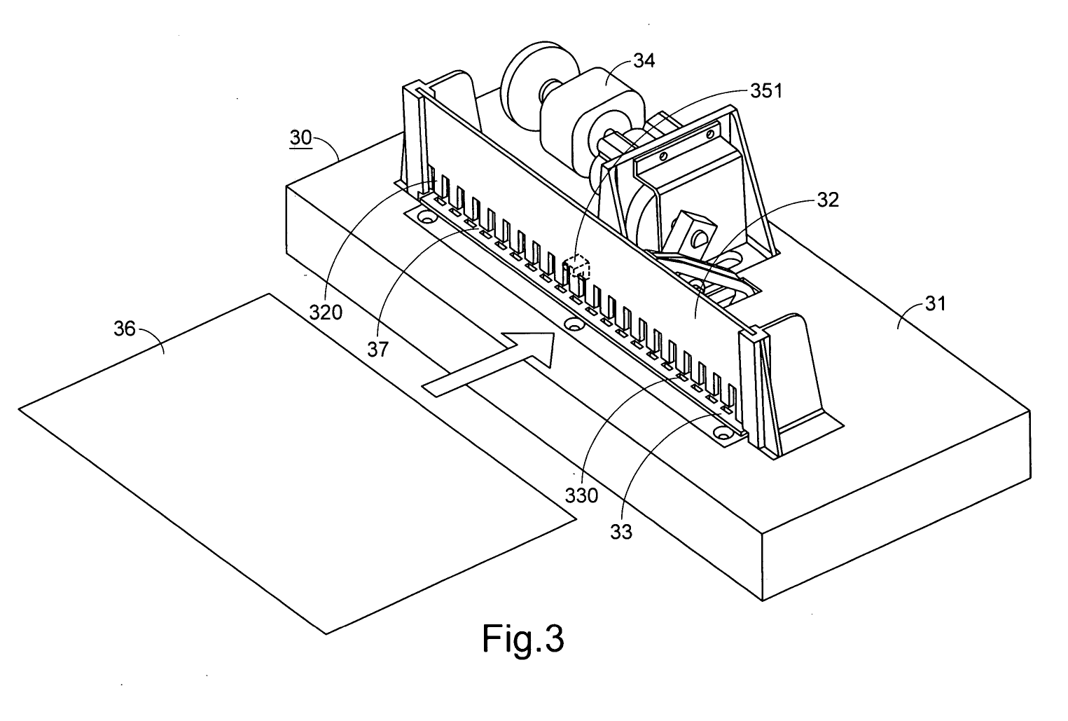

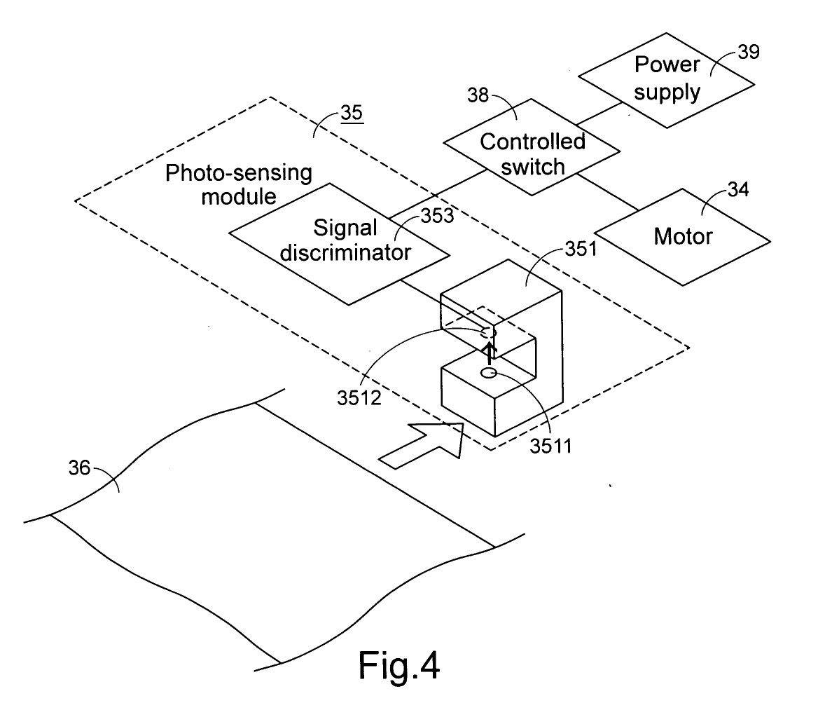

Please refer to FIGS. 3 and 4. An automatic punching apparatus 30 according to a preferred embodiment of the present invention comprises a base 31, a cutting tool 32, a fixture plate 33, a motor 34 and an actuation device 35. The cutting tool 32 has a plurality of punch pins 320 parallel to one another. The fixture plate 33 has a plurality of openings 330 corresponding to the punch pins 320. Between the cutting tool 32 and the fixture plate 33 is defined with a feeding entrance 37 for feeding therefrom paper sheet(s) 36 to be punched.

The actuation device 35 is substantially a photo-sensing module including a photo-sensor 351 and a signal discriminator 353. The photo-sensor 351 is disposed around the feeding entrance 37 and comprises a signal generator 3511 and a signal receiver 3512 facing to each other. The signal generator 3511 continuously generates an infrared-ray (IR) signal, which is supposed to be continuously received by the signal receiver 3512. In such manner, an optical way from the signal generator 3511 to the signal receiver 3512 is created in the feeding entrance 37. When the paper sheets 36 is intended to be placed on a top surface of the base 31 to be punched, a front thereof is fed into the feeding entrance 37 so as to interrupt the optical way. If the optical way is continuously interrupted for a predetermined time period, it is determined that there are paper sheets inserted into the feeding entrance 37 and ready to be punched. The predetermined time period, for example, is preferably set to be a time period enough for achieving proper alignment of the paper sheets. In response to the interruption of the optical way, the signal discriminator 353 asserts an actuation signal. In response to the actuation signal, the controlled switch 38 is switched on to actuate the motor 34 to drive the cutting tool 32 to move downward and dig into the paper sheets 36, thereby creating holes in the paper sheets. The electric power for activating the apparatus can be provided by an AC power supply, and the controlled switch 38, in this case, can be a thyristor. After the punching operation is finished, the punch pins 320 are released from the openings 330 so that the paper sheets 36 can be withdrawn from the feeding entrance 37. Meanwhile, the optical way from the signal generator 3511 to signal receiver 3512 is conducted again to wait for next paper feeding and punching operation.

In another embodiment, the actuation device 35 further comprises an additional photo-sensor 352 in addition to the photo-sensor 351 and the signal discriminator 353. The second photo-sensor 352, like the first photo-sensor 351, is disposed around the feeding entrance 37, but a distance separate from the first photo-sensor 351. Both of the first and second photo-sensors 351 and 352 are electrically connected to the signal discriminator 353 that is further electrically connected to the controlled switch 38. The second photo-sensor 352 comprises a signal generator 3521 and a signal receiver 3522 facing to each other. The signal generator 3521 continuously generates an infrared-ray (IR) signal, which is supposed to be continuously received by the signal receiver 3522 to create another optical way in the feeding entrance 37. In this embodiment, the actuation signal is asserted to switch on the controlled switch 38 so as to actuate the motor 34 when both of the optical ways in the feeding entrance are interrupted by the paper sheets 36 for a predetermined time period. It is understood from the above description that the punching operation will not be performed until both the photo-sensors 351 and 352 detect the inserted paper sheets. In other words, the punching operation will not be performed if the paper sheets are not placed in position. Therefore, the disposition of the second photo-sensor 352 facilitates the assurance of the well placement of the paper sheets in the feeding entrance, thereby obtaining perfectly aligned punched holes.

In the above embodiments, the optical ways are continuous IR signals. It is understood, however, that the optical ways can also be other types of optical signal, e.g. laser, or the optical ways can be generated in a non-continuous but constant pattern, e.g. intermittent or periodic emission. As long as the preset pattern is interrupted to some extent, it is determined that the paper sheets to be punched are placed in position. Moreover, signals other than optical signal can be applied to the present invention as long as the interruption of the signal can be detected. Of course, the number and positions of the sensors can vary with practical requirement such as cost and precision. Further, the predetermined time period waiting for actuating the motor as mentioned above can be adjusted according to practical requirement. In order to achieve this purpose, a micro-controller can be used as the signal discriminator. Alternatively, if desired, the motor can be actuated immediately when the optical way or ways are interrupted without waiting the predetermined time period or with the setting of the predetermined time period as zero.

Further, the present invention is illustrated with paper sheets as the example of the punched object. Other sheet material can also be punched to create holes therein according to the present invention.

From the above description, the automatic punching apparatus of the present invention permits well alignment of the object to be punched because the user can hold the object with both of his hands. In addition, since no pedal switch is required, limited operating space is enough for the punching operation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. An actuation device of a punching apparatus, comprising:
a first signal generator generating a first signal in a first preset pattern;
a first signal receiver for receiving said first signal; and
a signal discriminator electrically connected to said first signal receiver to determine whether said first signal receiver receives said first signal in said first preset pattern, and asserting an actuation signal to actuate a punching operation of said punching apparatus when said first signal is interrupted from said first preset pattern.

2. The actuation device according to claim 1 wherein said first preset pattern is to have said first signal generator continuously generate said first signal and have said first signal receiver continuously receive said first signal.

3. The actuation device according to claim 2 wherein said actuation signal is asserted when said first signal is interrupted from continuous generation for a predetermined time period.

4. The actuation device according to claim 1 wherein said first preset pattern is to have said first signal generator periodically generate said first signal and have said first signal receiver periodically receive said first signal.

5. The actuation device according to claim 1 wherein said first signal is an infrared-ray (IR) signal.

6. The actuation device according to claim 1 wherein said punching apparatus comprises:
a base for placing thereon an object to be punched;
a motor;
a controlled switch electrically connected to said signal discriminator and said motor, and switched on to actuate said motor in response to said actuation signal;
a cutting tool having a plurality of punch pins driven by said motor to dig into said object so as to perform said punching operation; and
a fixture plate having a plurality of openings for receiving said punch pins, wherein a feeding entrance is defined between said cutting tool and said fixture plate defining for feeding therefrom said object to be punched.

7. The actuation device according to claim 6 wherein said first signal generator and said first signal receiver are arranged at the same side of said base and opposite to each other so that said object, once placed into said feeding entrance, interrupts said first signal in said first preset pattern.

8. The actuation device according to claim 7 further comprising:
a second signal generator disposed at a side of said base distant from said first signal generator and generating a second signal in a second preset pattern; and
a second signal receiver for receiving said second signal in said second preset pattern, said second signal receiver being electrically connected to said signal discriminator and disposed at the same side of said base as said second signal generator, wherein said signal discriminator asserts said actuation signal when both of said first and said second signal are interrupted from said first and second preset patterns, respectively, by said object placed into said feeding entrance.

9. The actuation device according to claim 8 wherein said second signal is an infrared-ray (IR) signal.

10. The actuation device according to claim 1 wherein said signal discriminator is a micro-controller.

11. The actuation device according to claim 1 for use in a paper puncher.

12. An automatic punching apparatus comprising:
a base for placing thereon an object to be punched;
a cutting tool digging into said object to create holes;
a photo-sensing module disposed around a feeding entrance where said object is inserted between said base and said cutting tool, and generating an actuation signal when said photo sensing module detects said object has been in place;
a controlled switch electrically connected to said photo-sensing module and switching on in response to said actuation signal; and
a motor electrically connected to said controlled switch and actuated to transmit said cutting tool to dig into said object when said controlled switch is on.

13. The automatic punching apparatus according to claim 12 wherein said photo-sensing module includes:
a first signal generator generating a first signal in a first preset pattern;
a first signal receiver for receiving said first signal; and
a signal discriminator electrically connected to said first signal receiver, determining that said object has not entered said feeding entrance when said first signal receiver receives said first signal in said first preset pattern, and determining that said object has been placed in said feeding entrance so as to assert said actuation signal when said first signal is interrupted from said first preset pattern by said object placed into said feeding entrance.

14. The automatic punching apparatus according to claim 13 wherein said photo-sensing module further comprises:
a second signal generator disposed at a side of said base distant from said first signal generator and generating a second signal in a second preset pattern; and
a second signal receiver for receiving said second signal in said second preset pattern, electrically connected to said signal discriminator in a manner that said signal discriminator asserts said actuation signal when both of said first and said second signal are interrupted from said first and second preset patterns, respectively, by said object placed into said feeding entrance.

15. The automatic punching apparatus according to claim 14 wherein said first and second preset patterns are to have said first and second signal generators continuously generate said first and second signals and have said first and second signal receivers continuously receive said first and second signals, respectively.

16. The automatic punching apparatus according to claim 15 wherein said actuation signal is asserted when both of said first and second signals are interrupted from continuous generation for a predetermined time period.

17. The automatic punching apparatus according to claim 15 wherein said first and second signals are infrared-ray signals.

18. The automatic punching apparatus according to claim 13 wherein said signal discriminator is a micro-controller.

19. A method for automatically actuating a punching apparatus, comprising steps of:
providing at least one optical way in a paper-feeding entrance of said punching apparatus;
monitoring whether said optical way is interrupted;
generating an actuation signal when said optical way is interrupted for a predetermined time period; and
actuating said punching apparatus to perform a punching operation in response to said actuation signal.

20. The method according to claim 19 wherein two optical ways distant from each other are provided in said paper-feeding entrance, and said actuation signal is generated when both of said optical ways are interrupted for said predetermined time period.
